(19) United States
(12) Patent Application Publication
(10) Pub. No.: US 2022/0012579 A1
(43) Pub. Date: Jan. 13, 2022

(54) NEURAL NETWORK ACCELERATOR SYSTEM FOR IMPROVING SEMANTIC IMAGE SEGMENTATION

(71) Applicants: Masayoshi Asama, San Jose, CA (US); Petrus Van Beek, Vancouver, WA (US); Ben Berlin, Santa Clara, CA (US)

(72) Inventors: Masayoshi Asama, San Jose, CA (US); Petrus Van Beek, Vancouver, WA (US); Ben Berlin, Santa Clara, CA (US)

(21) Appl. No.: 17/484,918

(22) Filed: Sep. 24, 2021

(51) Int. Cl. G06N 3/063

(52) U.S. Cl. CPC G06N 3/063

(57) ABSTRACT

Methods, systems, apparatus, and articles of manufacture to improve semantic image segmentation with a neural network accelerator system. Disclosed examples include an apparatus to perform semantic image segmentation comprising: mode selecting circuitry to transmit an input image to at least one of vision network circuitry and imaging network circuitry; the vision network circuitry to generate a first output based on a first feature map of a the input image being generated by image scaling circuitry; the imaging network circuitry to generate a second output of the input image; bottleneck extender circuitry to: upscale the first output to a resolution based on the second output; concatenate the first and second output to generate a concatenated output; and apply a convolution operation to the concatenated output; and segmentation head circuitry to generate a pixel level segmentation class map from the concatenated output.

### FIELD OF THE DISCLOSURE

This disclosure relates generally to neural networks and, more particularly, to methods, systems, apparatus, and articles of manufacture to improve semantic image segmentation with a neural network accelerator system.

### BACKGROUND

In machine learning, a convolutional neural network is a type of feed-forward artificial network which captures spatial and temporal dependencies in an image through the application of filters. Convolutional neural networks are widely used throughout computer vision to allow computer systems to derive a high-level understanding of images. Common computer vision tasks include image classification and object detection.

Image classification seeks to identify categories of objects in images. Object detection seeks to define the general location of these objects, often by generating a bounding box for each object. In recent years, a technique called semantic image segmentation has developed from these foundations to define object location with greater exactness. Specifically, in semantic image segmentation, each pixel of an image is categorized based on the object and/or category to which the pixel belongs.

### BRIEF DESCRIPTION OF THE DRAWINGS

FIG. 1A is a schematic illustration of a deep neural network accelerator system constructed in a manner consistent with this disclosure.

FIG. 1B is an illustration of the example bottleneck extender circuitry and the example imaging network circuitry.

FIG. 2 is another illustration of the example bottleneck extender circuitry of FIGS. 1A and 1B.

FIG. 3A is another illustration of the example imaging network circuitry of FIGS. 1A and 1B.

FIG. 3B is an illustration of example convolution circuitry.

FIG. 4 is an illustration of example semantic segmentation maps generated by various system types.

FIG. 5 is a flowchart representative of example machine readable instructions that may be executed by example processor circuitry to implement the deep neural network accelerator system of FIG. 1.

FIG. 6 is a flowchart representative of example machine readable instructions that may be executed by example processor circuitry to implement the imaging network encoder of FIG. 3A.

FIG. 7 is a flowchart representative of example machine readable instructions that may be executed by example processor circuitry to implement the bottleneck extender circuitry 106.

FIG. 8 is a flowchart representative of example machine readable instructions that may be executed by example processor circuitry to implement the imaging network encoder of FIGS. 1A and 3A.

FIG. 9 is a block diagram of an example processing platform including processor circuitry structured to execute the example machine readable instructions of FIGS. 5-8 to implement the deep neural network accelerator system of FIG. 1.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 5-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Deep learning leverages deep artificial neural networks (DNNs) to automate the discovery of relevant features from input data. Many types of artificial neural networks are used in deep learning, including convolutional neural networks (CNNs). CNNs can be especially useful for imaging tasks. For example, raw pixels from an image may be fed to a series of convolutional layers and max-pooling layers. As data moves through the layers, increasingly abstract features are extracted from the image. These features are used for classification.

These general concepts form the foundation of semantic image segmentation. As used herein, semantic image segmentation is a technique in which pixels of an image are categorized based on the object to which the pixel belongs. Traditionally, semantic image segmentation required large, centralized computer servers. However, the increasing power and efficiency of computer hardware has made such deep learning tasks possible on edge computing devices. In general, edge computing acts on data as close to the source as possible, which has the advantage of reducing communication overhead because the data does not have to be sent off-device for processing.

DNN hardware topologies vary widely, but one common approach today is to have a general purpose programmable CNN accelerator operating as an inference engine. The general purpose programmable CNN accelerator is then programmed to perform a variety of different tasks. Such an approach is extremely flexible, but comes at a significant computational cost. Dynamic random access memory (DRAM) accesses, with hundreds of direct memory access transfers, may be required to hold and switch intermediate feature maps and weights. This is computationally intensive and causes the system to consume a relatively large amount of power.

For very low-power embedded applications, fixed topology hardware networks are preferable. Typically focused on a single task, fixed topology networks offer high performance and power-efficiency. However, such hardware networks are relatively inflexible. For this reason, multiple fixed-topology hardware designs may be necessary to perform the relevant imaging and vision tasks of a single programmable CNN accelerator. This complexity presents architectural challenges to which embodiments discussed herein provide a technical solution.

For example, a system may use separate fixed topology networks for imaging and computer vision tasks. Imaging tasks (e.g., producing pixels) consume and produce high-resolution input and output. Effects like deblur, denoise, color reproduction, depth map refinement, etc., require a network capable of receiving input pixels and producing output pixels with the same resolution as the input. In imaging tasks, there is no need to differentiate the high-level structure or precise class of the object, thus the number of feature maps (e.g., channels) required for imaging tasks is relatively low. In general, the topology for such circumstances needs to be high performance and high throughput.

A vision task, such as image classification or object detection, typically outputs classification or detection information and does not produce output pixels. This is because the purpose of many vision tasks is detecting or classifying objects. High resolution input is often not required, and the final output usually contains information at much lower resolution. Overall, a recommended fixed topology solution for a vision task may use a low pixel per clock rate, which indicates relatively lower throughput.

A conventional imaging network cannot handle semantic image segmentation tasks, as it lacks a sufficient number of feature maps. On the other hand, a vision network has enough feature maps to handle classification, but vision networks typically output very low-resolution feature maps. This does not, for example, allow small objects (e.g., objects at far distance) to be detected. Accordingly, neither the conventional imaging engine nor the conventional vision engine can handle semantic segmentation alone.

Examples disclosed herein combine imaging and vision fixed function topologies into a single network capable of efficient semantic image segmentation. Examples include bottleneck extender circuitry to connect the image network and the vision network. The bottleneck extender circuitry facilitates high throughput, high resolution input/output, and high classification accuracy. Additionally, in some embodiments, the image and vision networks can operate independently.

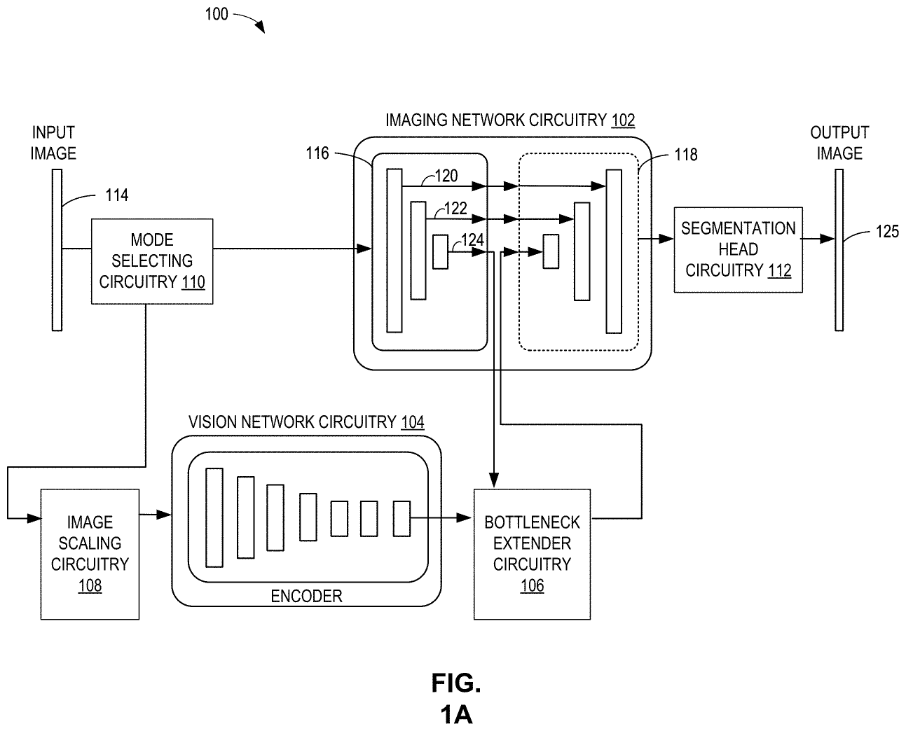

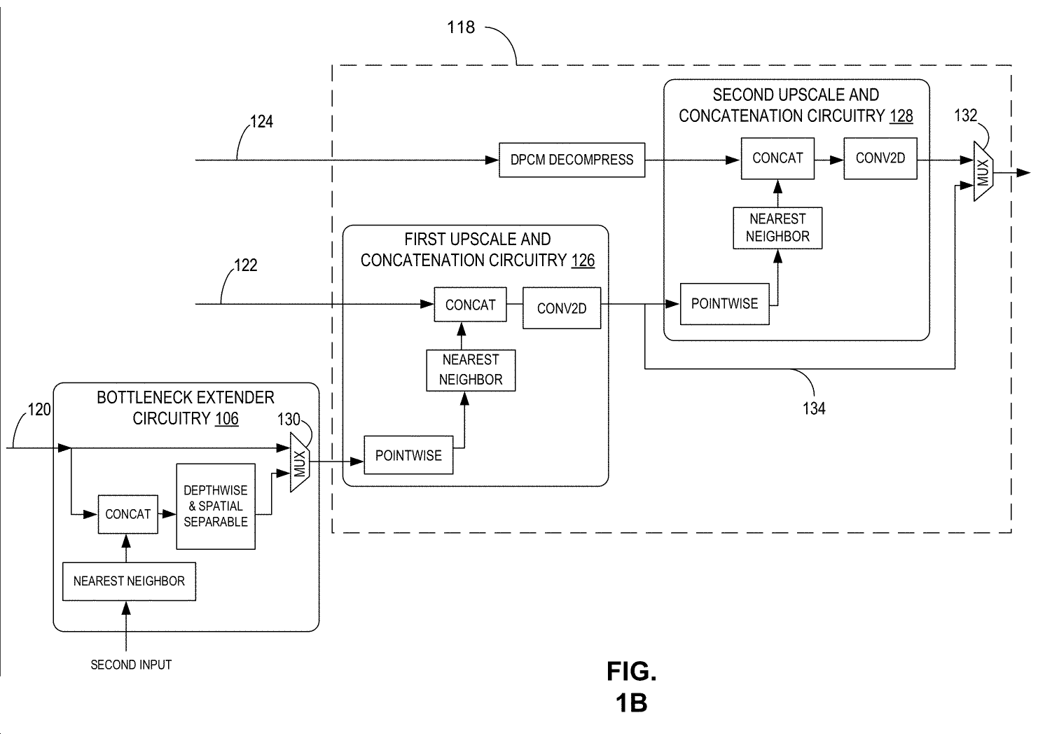

Turning to the figures, FIG. 1A is a schematic illustration of an example deep neural network accelerator system 100. The example deep neural network accelerator system 100 includes example imaging network circuitry 102, example vision network circuitry 104, example bottleneck extender circuitry 106, example image scaling circuitry 108, example mode selecting circuitry 110, example segmentation head circuitry 112, an example input image 114, an example imaging network encoder 116, an example imaging network decoder 118, an example first pipeline 120, an example second pipeline 122, an example third pipeline 124, and an example output image 125.

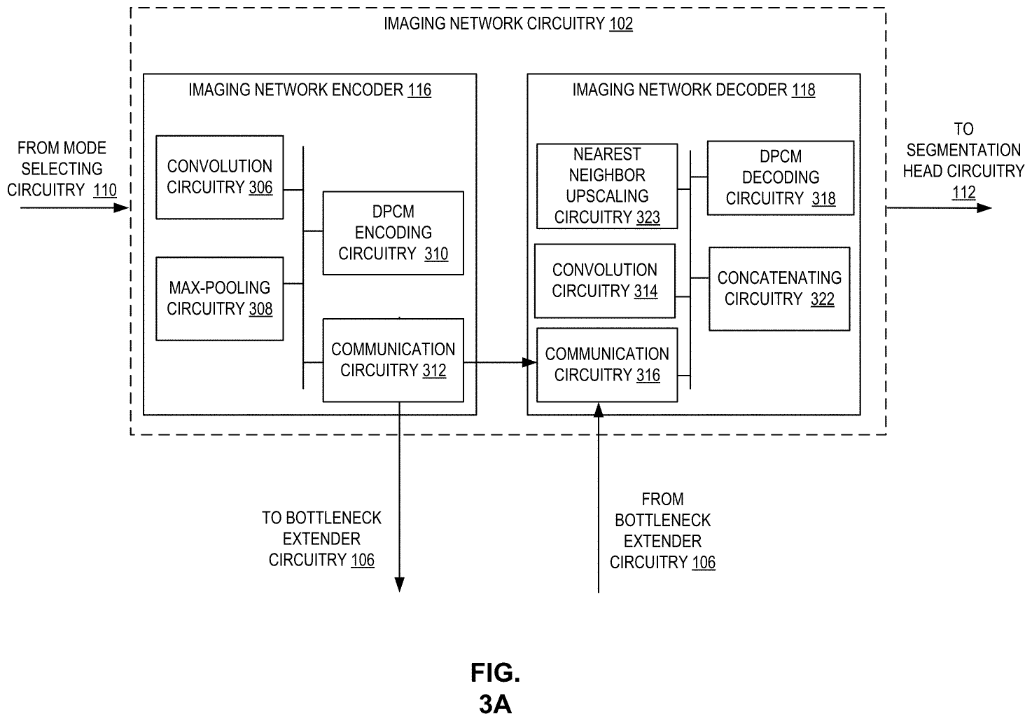

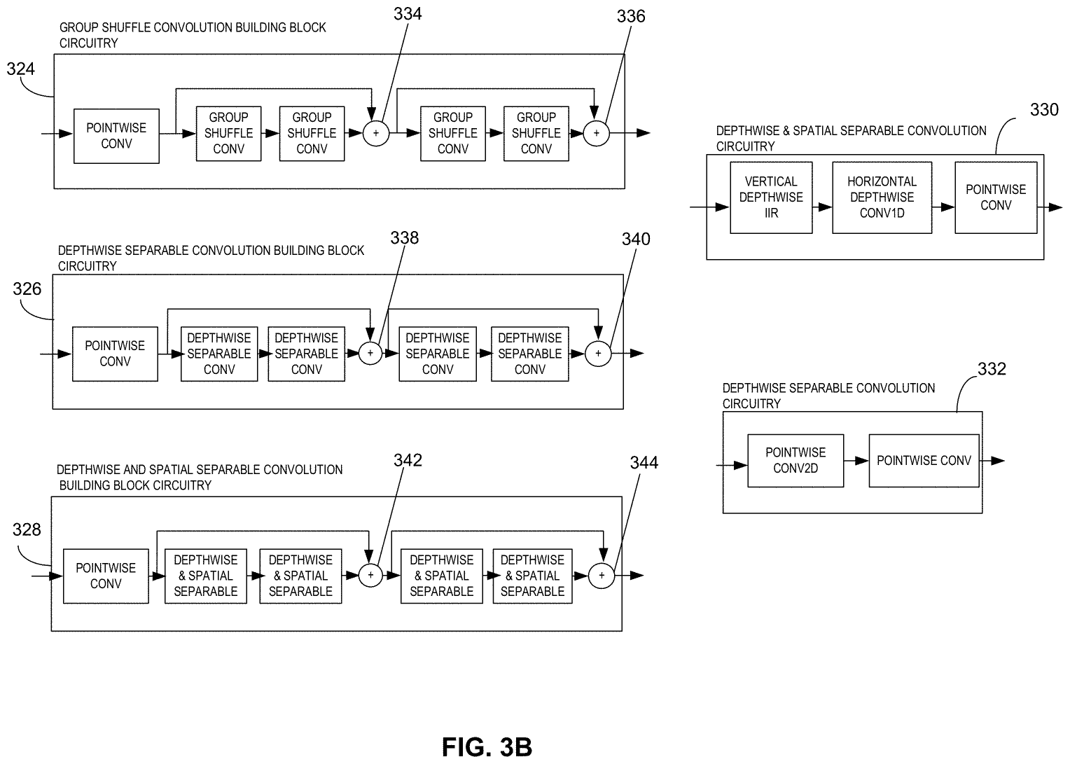

The example imaging network circuitry 102 includes the imaging network encoder 116 and the imaging network decoder 118. The example imaging network encoder 116 extracts a feature map from the image by extracting characteristics (e.g., flat/texture/edge) of objects. The example imaging network decoder 118 then treats characteristics of the object differently, producing pixels and fixing image distortion. Real-time imaging systems typically operate at a frame rate of at least 30 frames per second and an output resolution of 1080p. In some examples, 72 feature maps is sufficient for handling imaging tasks. In some examples, the imaging network encoder 116 of the imaging network circuitry 102 may have three downscaled resolutions (1×, 4×, 16×), and the encoded feature map may have 72 feature maps of 16× downscaled resolution. In such examples, the imaging network circuitry may include a u-net like encoder and decoder network. The imaging network circuitry 102 is described in further detail below in association with FIG. 3A.

The example vision network circuitry 104 may function as an encoder. The vision network circuitry 104 extracts a feature map from an input image. This involves extracting high-level structure and semantics of objects, which allows discrimination between classes and sub-classes (e.g. cats versus dogs, subspecies of cats and dogs, etc.). Accordingly, the number of feature maps required for a vision task is relatively high (e.g., as compared to that required for an imaging task.). For example, 512 or 768 feature maps may be necessary for some vision tasks. The vision network circuitry 104 is a fixed topology network, which includes multipliers, weights, and buffers. As a fixed topology network, the vision network circuitry 104 performs a consistent series of tasks, and can therefore be optimized for those tasks (e.g., low power for embedded operation). However, as described above, the vision network circuitry 104 may not include a high resolution input/output network, as the final output contains information at lower resolution. Additionally, in some examples, the vision network circuitry 104 includes a mobilenet or shufflenet like encoder network.

The example image scaling circuitry 108 is an image scaler for vision tasks. The image scaling circuitry 108 scales the input image 114 by down-sampling and generating feature maps or enhanced images of smaller size. Thus, the feature maps or enhanced images can be transmitted to the vision network circuitry 104 more efficiently. In some examples, input images may be downscaled by 4× in each dimension.

The output of the image scaling circuitry 108 is fed to the vision network circuitry 104. The vision network circuitry 104 encodes the image, extracting the high-level structure and semantics of the objects. The encoded feature map may, for example, contain 768 channels at 16× downscaled resolution. In such an example, an output may contain 768 channels of 64× downscaled resolution feature maps.

In some examples, the image scaling circuitry 108 may include a trainable vision scaler (TVS). The TVS is a neural network framework that may be trained to receive an input data and generate output feature maps or enhanced images to the vision network circuitry 104. In some examples, the generated output feature maps may be smaller in size compared to the input data. In some examples, the image scaling circuitry 108 scales input data by down-sampling and generating features maps or enhanced images of smaller size. The image scaling circuitry 108 may increase accuracy when compared to non-trainable image scaling circuitry.

The mode selecting circuitry 110 controls which of the imaging network circuitry 102 and the vision network circuitry 104 will receive the input image 114. The deep neural network accelerator system 100 transmits the input image 114 to both the imaging network circuitry 102 and the vision network circuitry 104, which are connected and enhanced by the bottleneck extender circuitry 106. Generally speaking, at least one benefit related to disclosed examples herein is that the bottleneck extender circuitry improves semantic segmentation accuracy and data throughput by enabling the vision network circuitry 104 and the imaging network circuitry 102 to be combined in a single system.

In some examples, the mode selecting circuitry 110 may only transmit the input image 114 to either the imaging network circuitry 102 or the vision network circuitry 104. For example, a pure imaging task may not utilize the bottleneck extender circuitry 106 and/or the vision network circuitry 104. Likewise, a pure vision task may not utilize the imaging network circuitry 102. By selecting effective operations on the input image 114 based on the task provided, the mode selecting circuitry allows the deep neural network accelerator system 100 to save energy while maintaining flexibility.

The example deep neural network accelerator system 100 is trained as a single network. In some examples, a single segmentation head is used. The example of FIG. 1A includes a single input (e.g., the example input image 114), and a single output (e.g., the example output image 125). A combined model is trained, and weights in both the vision network circuitry 104 and the imaging network circuitry 102 are updated as a result of the training process. Such training may be carried out using a variety of open source frameworks.

After training, the trained weights for the convolutional neural network accelerator system 100 are saved (e.g., stored in memory). Then, to prepare for semantic image segmentation, the trained weights are loaded into corresponding hardware blocks (e.g., the vision network circuitry 104, the imaging network circuitry 102). In examples where only one of the vision network circuitry 104 or the imaging network circuitry 102 is used, each network is loaded with the corresponding pre-trained weights for that example. In such examples, the vision network circuitry 104 and the imaging network circuitry 102 may be trained separately.

In operation, the deep neural network accelerator system 100 performs semantic image segmentation on the example input image 114. The input image 114 is transmitted, via the mode selecting circuitry 110, to both the imaging network circuitry 102 and the image scaling circuitry 108. The image scaling circuitry 108 downscales the image, which is provided to the vision network circuitry 104. The bottleneck extender circuitry 106 takes the output of the vision network circuitry 104 and may upscale it to the same resolution as the imaging network encoder 116 output. The bottleneck extender circuitry 106 additionally concatenates both outputs and may apply convolution. As described above, the bottleneck extender circuitry 106 connects the imaging network circuitry 102 and the vision network circuitry 104 in this example arrangement to, at least, generate output of a high resolution with high throughput and improved accuracy. Output of the bottleneck extender circuitry 106 is transmitted to the imaging network decoder 118, and then to the segmentation head circuitry 112. In some examples, the imaging network decoder 118 may use additional inputs from the imaging network encoder 116. Such additional inputs are called skip connections, as the input skips at least one layer in the neural network, providing input to a later layer. An example result is the output image 125, which is a full-resolution pixel-level segmentation class map of relatively high accuracy and resolution (e.g., compared to prior solutions).

Thus, the architecture of the imaging network circuitry 102 and the vision network circuitry 104 is enhanced by, at least, the bottleneck extender circuitry 106. The bottleneck extender circuitry 106 enables a flexible combination of the vision network circuitry 104 and the imaging network circuitry 102, with significantly improved performance on semantic image segmentation tasks.

FIG. 1B is an illustration of the example bottleneck extender circuitry 106 and the example imaging network decoder 118. FIG. 1B includes the bottleneck extender circuitry 106, the imaging network decoder 118, the example first pipeline 124, the example second pipeline 122, the example third pipeline 120, the example first upscale and concatenation circuitry 126, the example second upscale and concatenation circuitry 128, an example first multiplexer 130, an example second multiplexer 132, and an example fourth pipeline 134.

The example bottleneck extender circuitry 106 receives an input (e.g., a first feature map) from the example third pipeline 120 of the example imaging network encoder 116. The bottleneck extender circuitry 106 additionally receives a second input to be upscaled. In some examples, the second input may include at least one feature map loaded from memory by the bottleneck extender circuitry 106. In some examples, the second input may be transmitted to the bottleneck extender circuitry 106 by the example vision network circuitry 104 and be of a relatively low resolution.

The example bottleneck extender circuitry 106 upscales the second input (e.g., from the vision network circuitry 104) based on nearest neighbor upscaling to generate an upscaled second input. The upscaled second input is then concatenated with the first input to generate a concatenated feature map. The bottleneck extender circuitry 106 may next perform depthwise and spatial separable convolutions on the concatenated feature map. The details of the depthwise and spatial separable convolution operations will be described in further detail in relation to FIG. 3B.

Additionally, the bottleneck extender circuitry 106 includes the first multiplexer 130. In some examples, the first multiplexer 130 is operated by the mode selecting circuitry 110 of FIG. 1A. For example, in a pure imaging task, the first multiplexer 130 can output data from the third pipeline 120 directly, thereby bypassing some or all of the operations of the bottleneck extender circuitry 106.

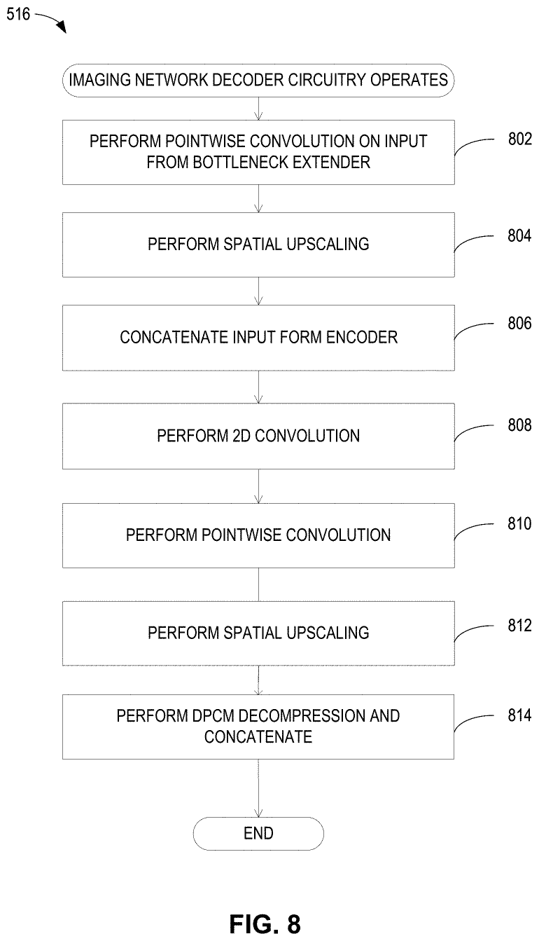

The imaging network decoder 118 receives input from the bottleneck extender circuitry 106, the example second pipeline 122, and the example third pipeline 124. The imaging network decoder 118 generally projects the features represented by the inputs of a plurality of pipelines (e.g., pipelines 120, 122, and 124) to a higher resolution pixel space. To accomplish this, the decoder includes the first upscale and concatenation circuitry 126 and the second upscale and concatenation circuitry 128. In some examples, the output of the first upscale and concatenation circuitry 126 is of a sufficient resolution for a given task. In such an example, the second multiplexer 132 can select the output from the example fourth pipeline 134. The detailed operation imaging network decoder will be further described below in relation to FIG. 3A and FIG. 8.

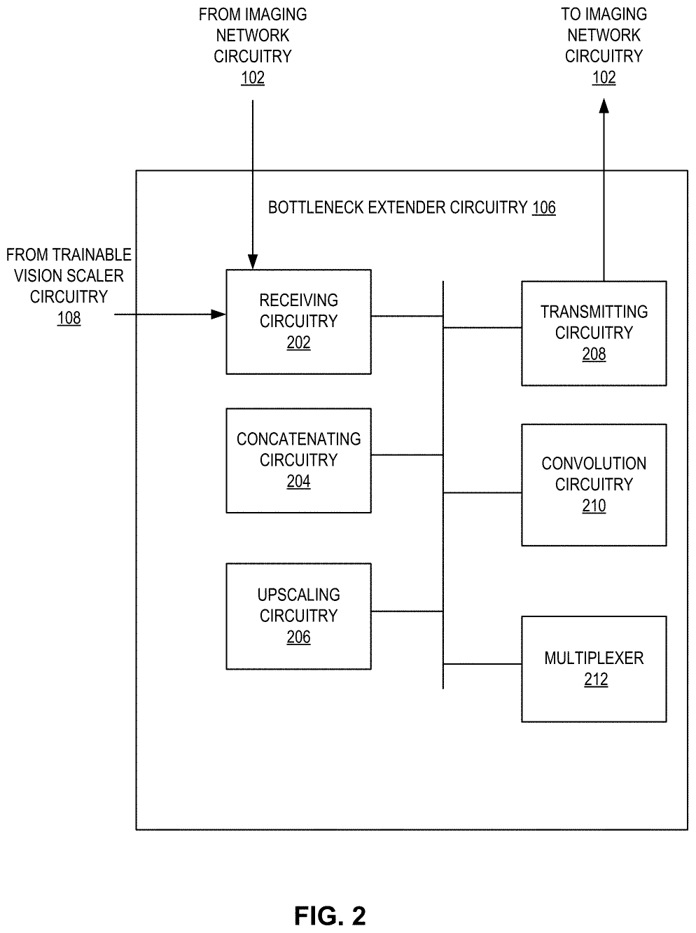

FIG. 2 is an illustration of the example bottleneck extender circuitry 106 of FIG. 1. The example bottleneck extender circuitry 106 includes receiving circuitry 202, concatenating circuitry 204, upscaling circuitry 206, transmitting circuitry 208, convolution circuitry 210, and a multiplexer 212.

The receiving circuitry 202 receives input data from both the vision network circuitry 104 and the imaging network circuitry 102. The receiving circuitry 202 may receive a different number of feature maps from each of the vision network circuitry 104 and/or the imaging network circuitry 102. For example, the output of the imaging network circuitry 102 may be a 72 channel encoded feature map corresponding to a 1920×1080 resolution input at 30 frames per second. The output of the vision network circuitry 104 may be a 768 channel encoded feature map corresponding to a VGA output at a lower resolution and 30 frames per second. In some examples, the receiving circuitry 202 may receive a feature map from memory.

The example upscaling circuitry 206 receives the output of the vision network circuitry 104 at a relatively lower resolution and upscales it to a relatively higher resolution corresponding to the imaging network circuitry 102. The upscaling circuitry 206 may implement a nearest-neighbor upscaling technique. The convolution circuitry 210 performs convolution operations, which may include grouped convolution, shuffled grouped convolution, spatially separable convolution, depthwise convolution, pointwise convolution, transposed convolution, etc. Furthermore, the spatially separable convolution may include an infinite impulse response (IIR) filter to perform vertical convolution. A vertical IIR filter is a spatially recursive filter that can reduce memory usage while enabling a large receptive field. The example upscaling circuitry 206 additionally performs nearest neighbor upscaling operations to prepare data for concatenation. In some examples, the transmitting circuitry 208 transmits the output of the bottleneck extender to a decoder of the imaging network circuitry 102.

In some examples, The bottleneck extender circuitry 106 includes the multiplexer 212. In operation, if the imaging network circuitry 102 is not used for semantic segmentation, then the multiplexer 212 enables a direct connection, in the bottleneck, between the imaging network encoder 116 and the imaging network decoder 118. In this way, the bottleneck extender circuitry 106 can be bypassed.

FIG. 3A is an illustration of the example imaging network circuitry 102 of FIG. 1A. The imaging network circuitry 102 includes an imaging network encoder 116 and an imaging network decoder 118. The imaging network encoder 116 includes convolution circuitry 306, max-pooling circuitry 308, differential pulse-code modulation (DPCM) encoding circuitry 310, communication circuitry 312. The imaging network decoder 118 includes convolution circuitry 314, communication circuitry 316, DPCM decoding circuitry 318, concatenating circuitry 322, and nearest neighbor upscaling circuitry 323.

The imaging network encoder 116 extracts a feature map from the input image 114. This could include extracting structural characteristics of objects within the input image 114. To accomplish this, the imaging network encoder 116 includes convolution circuitry 306 and max-pooling circuitry 308. In some examples, the convolution circuitry may include circuitry to perform regular convolutions, grouped convolutions, depthwise convolutions, and pointwise convolutions, as well as split and concatenation operators. For example, the convolution circuitry may perform a pointwise convolution, perform combinations of group and pointwise convolutions, and transmit an output to a plurality of pipelines. The first pipeline 120 of the plurality of pipes may perform a pointwise convolution in preparation for the DPCM encoding circuitry 310 to quantize the input signal using differential pulse code modulation. Max-pooling circuitry 308 may perform max-pooling in the second pipeline 122 of the plurality of pipelines. One or more regular convolutions, and/or depthwise convolutions, and/or pointwise convolutions may also be performed on the second pipeline 122.

Max-pooling circuitry 308 may additionally perform a max pooling on a third pipeline of the plurality of pipelines. The convolution circuitry 314 may perform one or more regular convolutions, depthwise convolutions, pointwise convolutions, and spatially separable convolutions on the third pipeline before the communication circuitry 316 transmits an intermediate output to the bottleneck extender circuitry 106. The spatially separable convolution may include the use of an IIR filter for vertical convolution. In the example of FIG. 1A, the bottleneck extender circuitry 106 is separate from the imaging network circuitry 102. In some examples, the bottleneck extender circuitry is integrated into the imaging network circuitry 102. In some examples, imaging network encoder 116 may include striding in one or more convolution operators, reducing aa spatial size of an image or intermediate features.

The imaging network decoder 118 produces pixels while fixing image distortion. To accomplish this, the imaging network decoder 118 includes convolution circuitry 306 and nearest neighbor upscaling circuitry 323. In some examples, the convolution circuitry 314 performs a two-dimensional convolution and a pointwise convolution. For example, the imaging network decoder 118 may receive input from a plurality of pipes. A third input from the plurality of pipes may be provided by the bottleneck extender circuitry 106. The convolution circuitry 314 and the nearest neighbor upscaling circuitry 323 may operate on the third input which can be concatenated with a second input by the concatenating circuitry 322. Additional convolutions may be performed on the first pipeline 122 before being concatenated with a first input, the first input decompressed by the DPCM decoding circuitry 318. In some examples, the decoder may include bilinear upscaling circuitry or use other upsampling techniques. In some examples, the decoder may include transpose convolution circuitry.

FIG. 3B is an illustration of example operations which may be performed by convolution circuitry (e.g., the example convolution circuitry 210, 306, 314). Example convolution circuitry illustrated in FIG. 3B includes example group shuffle convolution building block circuitry 324, example depthwise separable convolution building block circuitry 326, example depthwise and spatial separable convolution building block circuitry 328, example depthwise and spatial separable convolution circuitry 330, example depthwise separable convolution circuitry 332, and example skip connection concatenation circuitry 334-344.

The convolutional building block circuitry 324-326 may be included in various parts of the deep neural network accelerator system 100 (e.g., the bottleneck extender circuitry 106, the imaging network circuitry 102, etc.). Convolutional building block circuitry allow specific convolution operations to be performed efficiently via a fixed hardware topology.

The example group shuffle convolution building block circuitry 324 includes a pointwise convolution followed by a series of group shuffle convolutions. The example group shuffle convolution building block circuitry 324 additionally includes two skip connection concatenations 334 and 336, wherein an input skips at least one layer in the neural network, providing input to a later layer for concatenation.

The example depthwise separable convolution building block circuitry 326 includes a pointwise convolution followed by a series of depthwise separable convolutions. The depthwise separable convolutions may be performed by the depthwise separable convolution circuitry 332, which includes at least one pointwise two-dimensional convolution followed by at least one pointwise convolution. The example depthwise separable convolution building block circuitry 326 additionally includes two skip connection concatenations 338 and 340, wherein an input skips at least one layer in the neural network, providing input to a later layer for concatenation.

The example depthwise and spatial separable convolution building block circuitry 328 includes a pointwise convolution followed by a series of depthwise and spatial separable convolutions. The depthwise and spatial separable convolution operations may be performed by the depthwise and spatial separable convolution circuitry 330, which includes at least one vertical depthwise convolution, followed by at least one horizontal depthwise one-dimensional convolution, and at least one pointwise convolution. The depthwise and spatial separable convolution building block circuitry 328 additionally includes two skip connection concatenations 342 and 344, wherein an input skips at least one layer in the neural network, providing input to a later layer for concatenation.

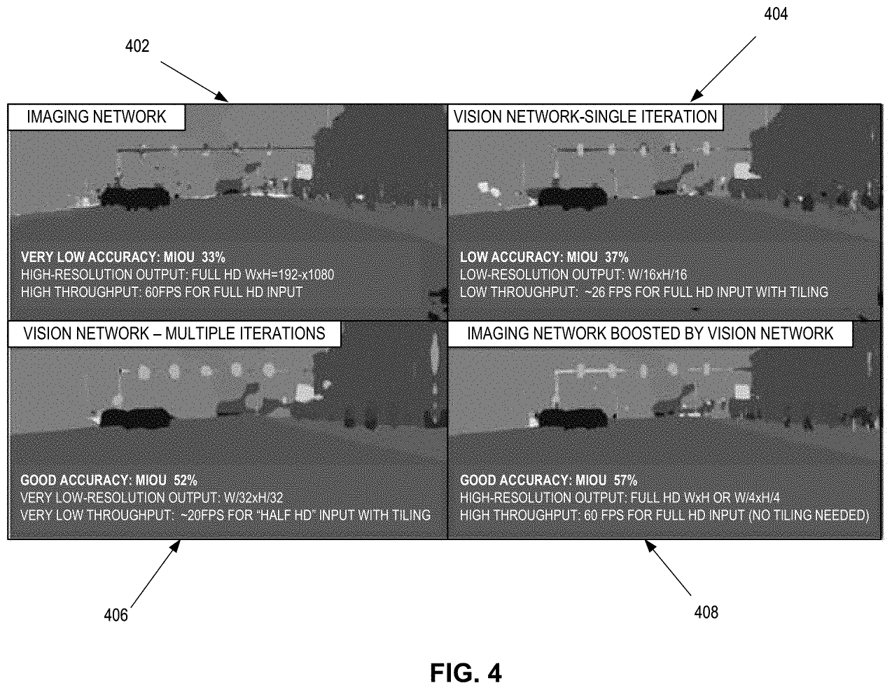

FIG. 4 provides example illustrations of semantic segmentation maps generated by various system types. In the examples of FIG. 4, the mean intersection over union (MIOU) performance metric is used. The example output image 402 illustrates an output using only the imaging network circuitry 102. The imaging network circuitry 102, by itself, generates high-resolution segmentation maps at high throughput. However, output image 402 also has very low MIOU accuracy.

Output image 404 illustrates an output from the example vision network circuitry 104 after a single iteration. While producing the output image 404 requires fewer operations, the output image 404 also has relatively lower MIOU accuracy, relatively lower resolution output, and relatively low throughput when compared to output of the deep neural network accelerator system 100.

Output image 406 illustrates the results of multiple iterations through the vision network circuitry 104. In some examples, rather than multiple iterations, the vision network circuitry 104 includes several repeating layers, increasing the depth of the network and increasing the number of features. Such a configuration achieves better MIOU at the cost of lower throughput. The vision network circuitry 104 may additionally include tiling to split a high-resolution input image into smaller sub-images. Such tiling and processing of multiple sub-images further reduces throughput. Even though the MIOU accuracy of output image 406 is sufficient, the output image 406 has a relatively low resolution. Additionally, detected object shapes do not follow their true shape, and objects in the output image 406 blend together. In general, it is relatively more difficult for the vision network circuitry 104 to properly classify small features with such a configuration.

The example output image 408 illustrates an example output of the deep neural network accelerator system 100 in a configuration in which the example imaging network circuitry 102, the example vision network circuitry 104, and the example bottleneck extender circuitry 106 operate together. The output image 408 has the highest MIOU accuracy of the example output images 402-408. The deep neural network accelerator system 100 also has relatively high throughput and generates segmentation maps with a relatively high resolution. Hence, the example deep neural network accelerator system 100 provides the advantages of both the stand-alone imaging and vision networks.

While an example manner of implementing the bottleneck extender circuitry 106 of FIG. 1A is illustrated in FIG. 2, one or more of the elements, processes, and/or devices illustrated in FIG. 2 may be combined, divided, re-arranged, omitted, eliminated, and/or implemented in any other way. Further, the example receiving circuitry 202, the example concatenating circuitry 204, the example upscaling circuitry 206, the example transmitting circuitry 208, the example convolution circuitry 210, and/or, more generally, the example bottleneck extender circuitry 106 of FIG. 2, may be implemented by hardware, software, firmware, and/or any combination of hardware, software, and/or firmware. Thus, for example, any of the example receiving circuitry 202, the example concatenating circuitry 204, the example upscaling circuitry 206, the example transmitting circuitry 208, the example convolution circuitry 210, and/or, more generally, the example bottleneck extender circuitry 106 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example receiving circuitry 202, the example concatenating circuitry 204, the example upscaling circuitry 206, the example transmitting circuitry 208, the example convolution circuitry 210, is/are hereby expressly defined to include a non-transitory computer readable storage device or storage disk such as a memory, a digital versatile disk (DVD), a compact disk (CD), a Blu-ray disk, etc., including the software and/or firmware. Further still, the example bottleneck extender circuitry 106 of FIG. 2 may include one or more elements, processes, and/or devices in addition to, or instead of, those illustrated in FIG. 2, and/or may include more than one of any or all of the illustrated elements, processes and devices.

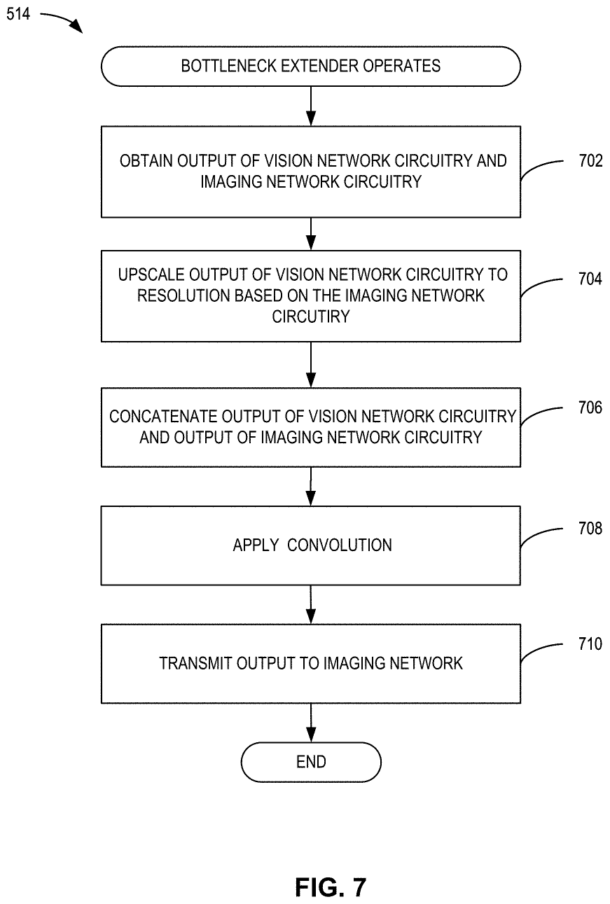

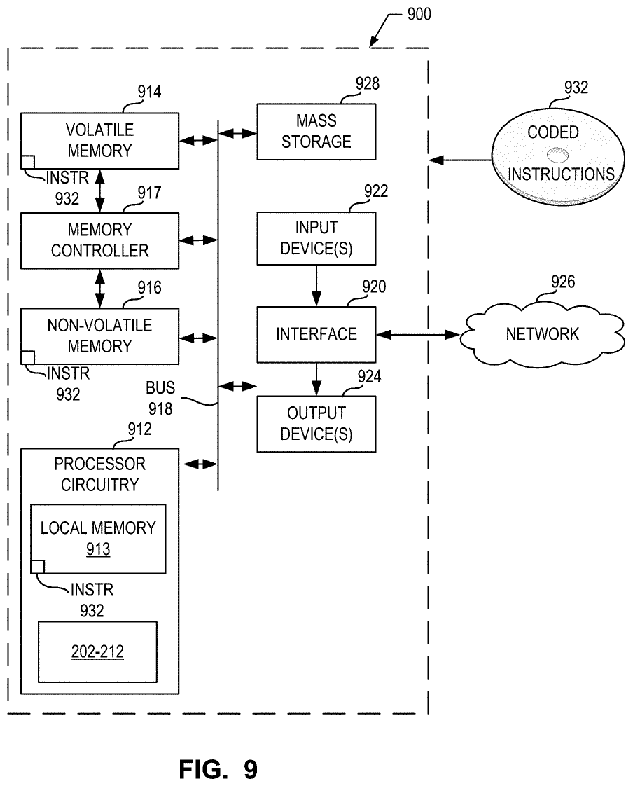

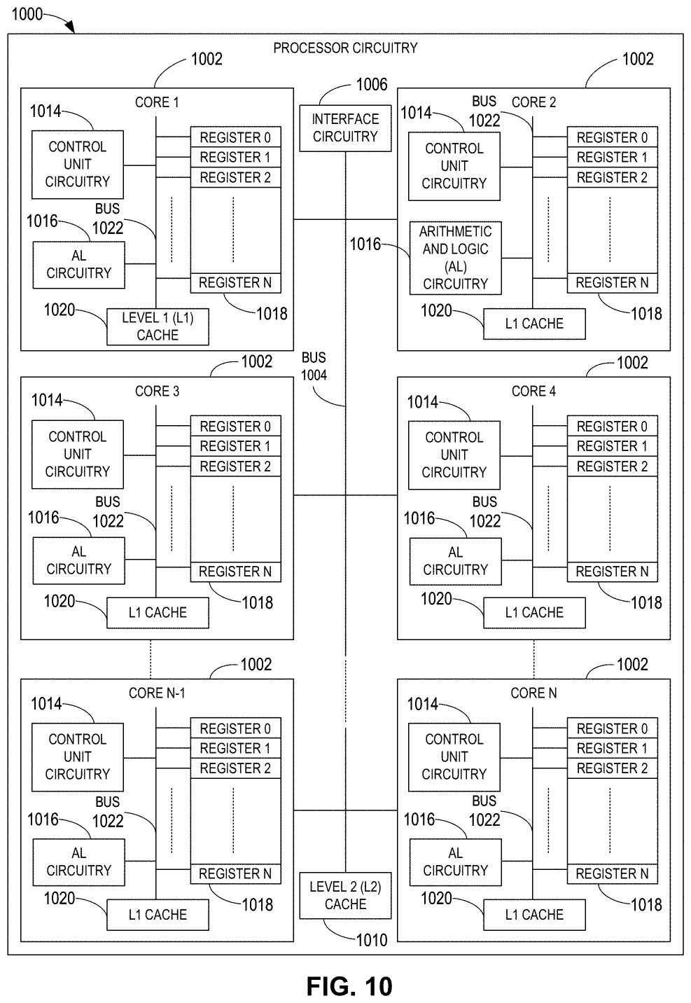

A flowchart representative of example hardware logic circuitry, machine readable instructions, hardware implemented state machines, and/or any combination thereof for implementing the bottleneck extender 106 is shown in FIG. 7. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in 7, many other methods of implementing the example bottleneck extender 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

While an example manner of implementing the imaging network circuitry 102 FIG. 1A is illustrated in FIG. 3A, one or more of the elements, processes, and/or devices illustrated in FIG. 3A may be combined, divided, re-arranged, omitted, eliminated, and/or implemented in any other way. Further, the example convolution circuitry 306, the example max-pooling circuitry 308, the example DPCM encoding circuitry 310, the example communication circuitry 312, the example nearest neighbor upscaling circuitry 323, the example convolution circuitry 314, the example communication circuitry 316, the example DPCM decoding circuitry 318, the example max-pooling circuitry 320, the example concatenating circuitry 322 and/or, more generally, the example imaging network circuitry 102 of FIG. 3A may be implemented by hardware, software, firmware, and/or any combination of hardware, software, and/or firmware. Thus, for example, any of the example convolution circuitry 306, the example max-pooling circuitry 308, the example DPCM encoding circuitry 310, the example communication circuitry 312, the example nearest neighbor upscaling circuitry 323, the example convolution circuitry 314, the example communication circuitry 316, the example DPCM decoding circuitry 318, the example max-pooling circuitry 320, the example concatenating circuitry 322, and/or, more generally, the example imaging network circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example convolution circuitry 306, the example max-pooling circuitry 308, the example DPCM encoding circuitry 310, the example communication circuitry 312, the example nearest neighbor upscaling circuitry 323, the example convolution circuitry 314, the example communication circuitry 316, the example DPCM decoding circuitry 318, the example max-pooling circuitry 320, the example concatenating circuitry 322 is/are hereby expressly defined to include a non-transitory computer readable storage device or storage disk such as a memory, a digital versatile disk (DVD), a compact disk (CD), a Blu-ray disk, etc., including the software and/or firmware. Further still, the example imaging network circuitry 102 of FIG. 3A may include one or more elements, processes, and/or devices in addition to, or instead of, those illustrated in FIG. 3A, and/or may include more than one of any or all of the illustrated elements, processes and devices.

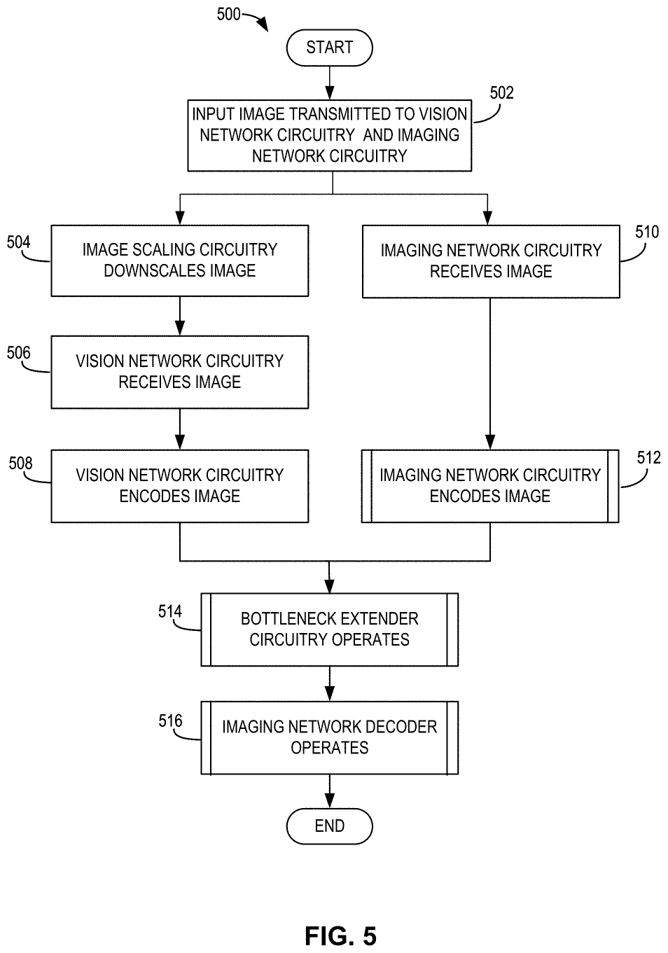

Flowcharts representative of example hardware logic circuitry, machine readable instructions, hardware implemented state machines, and/or any combination thereof for implementing the example deep neural network accelerator system 100 are shown in FIGS. 5 through 8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 5 to 8, many other methods of implementing the example deep neural network accelerator system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 1-3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

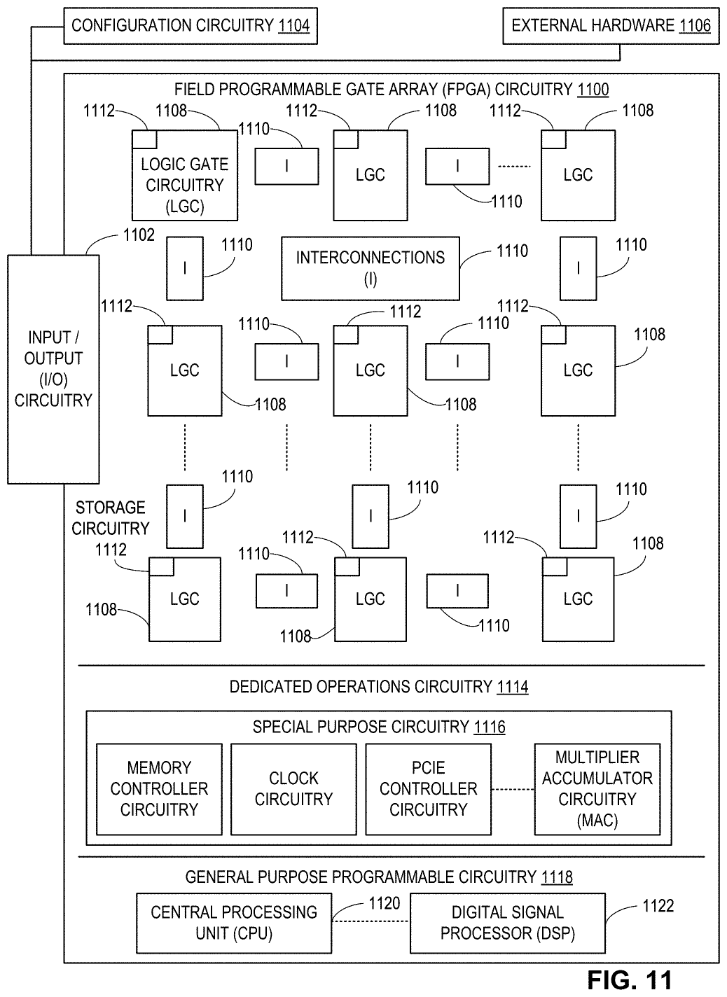

In some examples, the deep neural network accelerator system 100 includes means for transmitting an input image to at least one of vision network circuitry or imaging network circuitry. For example, the means for transmitting an input image to at least one of vision network circuitry or imaging network circuitry may be implemented by the mode selecting circuitry 110. In some examples, the mode selecting circuitry 110 may be implemented by machine executable instructions such as that implemented by at least block 502 of FIG. 5 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the mode selecting circuitry 110 is implemented by other hardware logic circuitry, hardware implemented state machines, and/or any other combination of hardware, software, and/or firmware. For example, the mode selecting circuitry 110 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the neural network accelerator system 100 includes means for means for generating a first output based on a first feature map of the input image being generated by image scaling circuitry . For example, the means for generating a first output based on a first feature map of the input image being generated by image scaling circuitry may be implemented by vision network circuitry 104. In some examples, the vision network circuitry 104 may be implemented by machine executable instructions such as that implemented by at least blocks 506, 508 of FIG. 5 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the vision network circuitry 104 is implemented by other hardware logic circuitry, hardware implemented state machines, and/or any other combination of hardware, software, and/or firmware. For example, the vision network circuitry 104 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

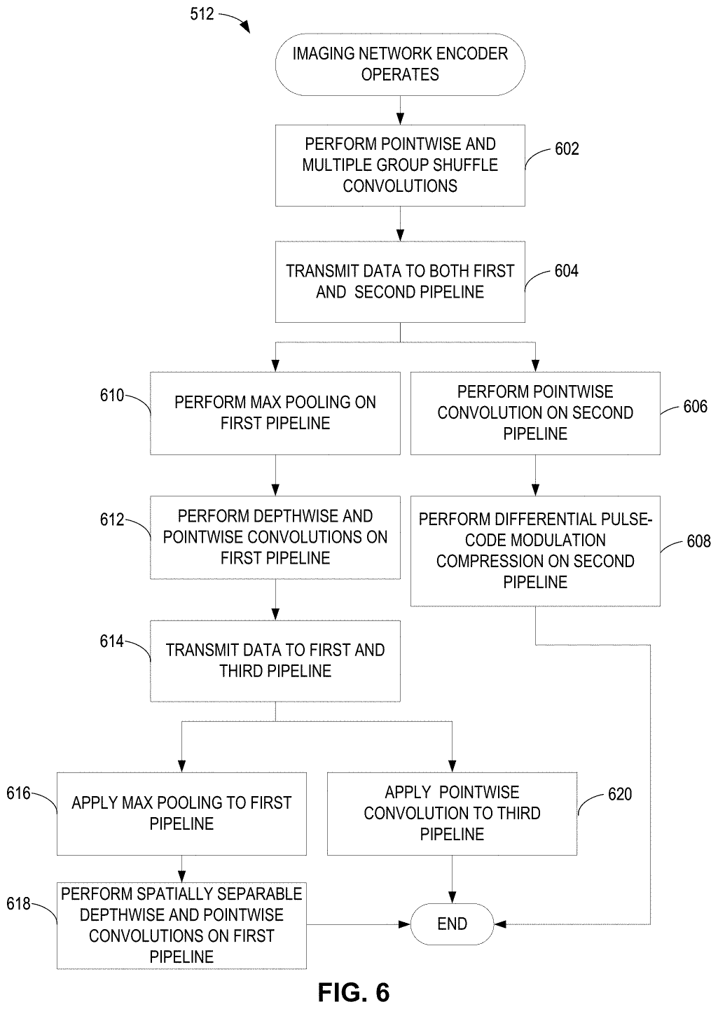

In some examples, the neural network accelerator system 100 includes means for generating a second output of the input image. For example, the means for generating a second output based on a second feature map of the input image may be implemented by imaging network encoder 116. In some examples, the imaging network encoder 116 may be implemented by machine executable instructions such as that implemented by at least blocks 510, 512 of FIGS. 5 and 602-620 of FIG. 6 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the imaging network encoder 116 is implemented by other hardware logic circuitry, hardware implemented state machines, and/or any other combination of hardware, software, and/or firmware. For example, the imaging network encoder 116 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the neural network accelerator system 100 includes means for concatenating the first and second output to generate a concatenated output and applying a convolution operation to the concatenated output. For example, the means for concatenating the first and second output to generate a concatenated output and applying a convolution operation to the concatenated output may be implemented by bottleneck extender circuitry 106. In some examples, the bottleneck extender circuitry 106 may be implemented by machine executable instructions such as that implemented by at least blocks 514 of FIGS. 5 and 702-710 of FIG. 7 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the bottleneck extender circuitry 106 is implemented by other hardware logic circuitry, hardware implemented state machines, and/or any other combination of hardware, software, and/or firmware. For example, the bottleneck extender circuitry 106 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the neural network accelerator system 100 includes means for generating a pixel level segmentation class map from the concatenated output. For example, the means for generating a pixel level segmentation class map from the concatenated output may be implemented by the imaging network decoder 118 and/or the segmentation head circuitry 112. In some examples, the imaging network decoder 118 and/or the segmentation head circuitry 112 may be implemented by machine executable instructions such as that implemented by at least blocks 516 of FIGS. 5 and 802-814 of FIG. 8 executed by processor circuitry, which may be implemented by the example processor circuitry 912 of FIG. 9, the example processor circuitry 1000 of FIG. 10, and/or the example Field Programmable Gate Array (FPGA) circuitry 1100 of FIG. 11. In other examples, the imaging network decoder 118 is implemented by other hardware logic circuitry, hardware implemented state machines, and/or any other combination of hardware, software, and/or firmware. For example, the imaging network decoder 118 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

FIG. 5 is a flowchart representative of example machine readable instructions that may be executed by example processor circuitry to implement the deep neural network accelerator system 100 of FIG. 1A. At block 502, the input image 114 (FIG. 1A) is transmitted to the example vision network circuitry 104 (FIG. 1A) and the example imaging network circuitry 104 (FIG. 1A) by the example mode selecting circuitry 110 (FIG. 1A). In some examples, the mode selecting circuitry 110 (FIG. 1A) may selectively transmit the input image 114 (FIG. 1A) to the imaging network circuitry 102 (FIG. 1A) (e.g., without transmitting the input image 114 (FIG. 1A) to the vision network circuitry 104 (FIG. 1A)). In some examples, the mode selecting circuitry 110 (FIG. 1A) may transmit the input image 114 (FIG. 1A) to the vision network circuitry 104 (FIG. 1A) without transmitting the input image 114 (FIG. 1A) to the imaging network circuitry 102 (FIG. 1A).

At block 504, the example image scaling circuitry 108 (FIG. 1A) downscales the example input image 114 (FIG. 1A). In some examples, the image scaling circuitry 108 (FIG. 1A) scales the input image 114 (FIG. 1A) by down-sampling and generating feature maps.

At block 506 the example vision network circuitry 104 (FIG. 1A) receives the example input image 114 (FIG. 1A) from the example image scaling circuitry 108 (FIG. 1A). At block 508, the example vision network circuitry 104 (FIG. 1A) encodes the example input image 114 (FIG. 1A). Encoding the input image 114 (FIG. 1A) may include extracting high-level structure and semantics of objects.

Block 510 illustrates a series of processes which may occur parallel to blocks 504-508. In block 510, the example imaging network circuitry 102 (FIG. 1A) also receives the example input image 114 (FIG. 1A). At block 512, the example imaging network circuitry 102 (FIG. 1A) encodes the example input image 114 (FIG. 1A). At block 514, the example bottleneck extender circuitry 106 (FIG. 1A) operates on data from both the example vision network circuitry 104 and the example imaging network encoder 116 (FIG. 1A).

At block 516, the example bottleneck extender circuitry 106 (FIG. 1A) then passes output to the example imaging network decoder 118 (FIG. 1A). The example bottleneck extender circuitry 106 (FIG. 1A) can take the output of the vision network circuitry 104 (FIG. 1A) and upscale it based on the resolution of the imaging network encoder 116 output. The bottleneck extender circuitry 106 (FIG. 1A) may additionally perform at least one concatenation and apply at least one convolution.

FIG. 6 is a flowchart representative of example machine readable instructions that may be executed by example processor circuitry to implement the imaging network encoder 116 of FIG. 1A. The instructions of FIG. 6 begin at block 512 (FIG. 5) where the example imaging network encoder 116 (FIG. 3A) begins operation.

At block 602, the example convolution circuitry 306 (FIG. 3A) performs pointwise and multiple group shuffle convolutions before data of the example input image 114 (FIG. 1A) is transmitted to the example first pipeline 120 and the example second pipeline 122 at block 604. At block 606, in the example second pipeline, the example convolution circuitry 306 (FIG. 3A) performs pointwise convolution on the example second pipeline before the example DPCM encoding circuitry 310 (FIG. 3A) operates on data at block 608.

In parallel with the example second pipeline, at block 610, the example max-pooling circuitry 308 (FIG. 3A) performs max pooling on the first pipeline 120 (FIG. 1). Max pooling may include calculating the maximum, or largest, value in a feature map. In some examples, an output of the max pooling circuitry 308 (FIG. 3A) can include downsampled feature maps that include highly present features. At block 612, the example convolution circuitry 306 (FIG. 3A) performs depthwise and pointwise convolutions on the example first pipeline 120 (FIG. 1A).

Next, at block 614, processing on the example first pipeline 120 (FIG. 1A) proceeds in parallel with processing in the example third pipeline 124 (FIG. 1A). In the example third pipeline 124 (FIG. 1A), at block 620, convolution circuitry 306 (FIG. 3A) performs a pointwise convolution. In parallel, at block 616 in the first pipeline 120 (FIG. 1A), the max-pooling circuitry 308 (FIG. 3A) performs max pooling. The process ends after, at block 618, the convolution circuitry 306 (FIG. 3A) performs spatially separable depthwise convolutions and pointwise convolutions on the example first pipeline 120 (FIG. 1A).

Through the example operations of FIG. 6, features from the input image 114 (FIG. 1A) are extracted. Additionally, data in the example third pipeline has been prepared for transmission to the example bottleneck extender circuitry 106 (FIG. 1A).

FIG. 7 is a flowchart representative of example machine readable instructions that may be executed by example processor circuitry to implement the bottleneck extender circuitry 106 (FIG. 1A). The instructions of FIG. 7 begin at block 514 (FIG. 5) where the bottleneck extender circuitry 106 (FIG. 1A) begins operation.

At block 702, the receiving circuitry 202 obtains output of the vision network circuitry 104 (FIG. 1A) and the imaging network circuitry (FIG. 2).

At block 704, the upscaling circuitry 206 (FIG. 2) takes the output of vision network circuitry 104 (FIG. 1A) and upscales it to a resolution based on the output of the output of the imaging network encoder 116 (FIG. 3A). In some examples, the output of the vision network circuitry 104 (FIG. 1A) may be upscaled to the same resolution as the output of the imaging network encoder 116 (FIG. 3A).

Next, at block 706, the concatenating circuitry 204 (FIG. 2) of the bottleneck extender circuitry 106 (FIG. 1A) concatenates output of vision network circuitry 104 (FIG. 1A) and output of imaging network circuitry 102 (FIG. 1A). At block 708, the convolution circuitry 210 (FIG. 2) applies convolution. Finally, at block 710, the transmitting circuitry 208 (FIG. 2) transmits the output back to the imaging network circuitry 102 (FIG. 1A).

Through the operations of FIG. 7, the bottleneck extender circuitry 106 (FIG. 1A) has connected the imaging network circuitry 102 and the vision network circuitry to generate output of a high resolution with high throughput and improved accuracy. The output of the bottleneck extender circuitry 106 (FIG. 1A) is prepared to be transmitted to the imaging network decoder 118.

FIG. 8 is a flowchart representative of example machine readable instructions that may be executed by example processor circuitry to implement the imaging network encoder of FIG. 3A. The instructions of FIG. 6 begin at block 516 (FIG. 5) where the imaging network decoder 118 (FIG. 3A) begins operation.

At block 802 the convolution circuitry 306 performs pointwise convolution on a third input from the bottleneck extender 106 (FIG. 1A). At block 804, the nearest neighbor upscaling circuitry 323 (FIG. 3A) performs spatial upscaling on the third input. At block 806, the concatenating circuitry 322 (FIG. 3A) concatenates the third input with a second input from a second pipeline of a plurality of pipes to create a first concatenated input. At block 808, the convolution circuitry 314 (FIG. 3A) performs a pointwise convolution. At block 810, the convolution circuitry 314 (FIG. 3A) performs a pointwise convolution. At block 812, the nearest neighbor upscaling circuitry 323 (FIG. 3A) performs spatial upscaling. Finally, at block 814, the DPCM decoding circuitry 318 and the concatenating circuitry 322 operate before the process ends.

FIG. 9 is a block diagram of an example processor platform 900 structured to execute and/or instantiate the machine readable instructions and/or operations of FIGS. 5-8 to implement the deep neural network accelerator system 100 of FIG. 1A. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the deep neural network accelerator system 100.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 932, which may be implemented by the machine readable instructions of FIGS. 5-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowchart of FIGS. 5-8.

The cores 1002 may communicate by an example bus 1004. In some examples, the bus 1004 may implement a communication bus to effectuate communication associated with one(s) of the cores 1002. For example, the bus 1004 may implement at least one of an Inter-Integrated Circuit (I2C) bus, a Serial Peripheral Interface (SPI) bus, a PCI bus, or a PCIe bus. Additionally or alternatively, the bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and an example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The bus 1020 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowchart of FIGS. 5-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowchart of FIGS. 5-8. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 5-8. As such, the FPGA circuitry 1100 may be structured to effectively instantiate some or all of the machine readable instructions of the flowchart of FIGS. 5-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 5-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIGS. 5-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowchart of FIGS. 5-8 may be executed by one or more of the cores 1002 of FIG. 10 and a second portion of the machine readable instructions represented by the flowcharts of FIGS. 5-8 may be executed by the FPGA circuitry 1100 of FIG. 11.

In some examples, the processor circuitry 912 of FIG. 9 may be in one or more packages. For example, the processor circuitry 900 of FIG. 9 and/or the FPGA circuitry 1100 of FIG. 6 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

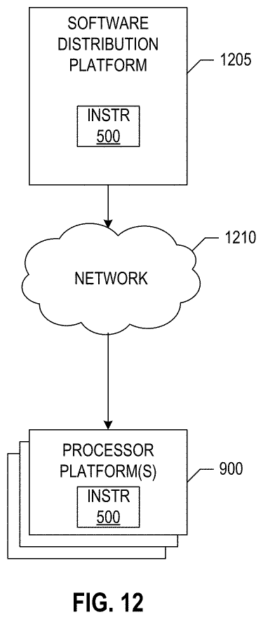

A block diagram illustrating an example software distribution platform 1205 to distribute software such as the example machine readable instructions 500 of FIGS. 5-8 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 500 of FIGS. 5-8. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 1232, which may correspond to the example machine readable instructions 500 of FIGS. 5-8, as described above. The one or more servers of the example software distribution platform 1205 are in communication with a network 1210, which may correspond to any one or more of the Internet and/or any other network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1205. For example, the software, which may correspond to the example machine readable instructions 500 of FIG. 5, may be downloaded to the example processor platform 900, which is to execute the machine readable instructions 500 to implement the deep neural network accelerator system 100. In some examples, one or more servers of the software distribution platform 1205 periodically offer, transmit, and/or force updates to the software (e.g., the example machine readable instructions 500 of FIGS. 5-8) to ensure improvements, patches, updates, etc., are distributed and applied to the software at the end user devices.

From the foregoing, it will be appreciated that example systems, methods, apparatus, and articles of manufacture have been disclosed that improve the functionality of computer systems performing semantic image segmentation. The disclosed systems, methods, apparatus, and articles of manufacture improve the efficiency of using a computing device by connecting vision and imaging networks while needing only a small amount of local SRAM for synchronization. The deep neural network accelerator system 100 supports high accuracy semantic segmentation results without DDR for up to 4K image resolution at 60 frames-per-second scenarios. This allows for edge computing systems to incorporate this solution to reduce power and total cost. Additionally, sub-frame latency is achieved by the deep neural network accelerator system 100 which is beneficial for near real-time systems (e.g. automated driving, industry automation) working directly on sensor data. This allows the automated system to respond to the sensed environment at low latency and with low accuracy. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to improve semantic image segmentation are disclosed herein. Further examples and combinations thereof include the following:

Example 1 includes an apparatus comprising at least one memory, instructions in the apparatus, and processor circuitry to execute the instructions to transmit an input image to at least one of vision network circuitry and imaging network circuitry, generate, by the vision network circuitry, a first output based on a first feature map of the input image being generated by image scaling circuitry, generate, by the imaging network circuitry, a second output of the input image, upscale the first output, by bottleneck extender circuitry, to a resolution based on the second output, concatenate the first and second output to generate a concatenated output, apply a convolution operation to the concatenated output, and generate, by segmentation head circuitry, a pixel level segmentation class map from the concatenated output.

Example 2 includes the apparatus of example 1, wherein the first feature map of the input image is a downscaled feature map describing features of the input image.

Example 3 includes the apparatus of example 1, wherein the processor circuitry is to execute the instructions to quantize the input image based on differential pulse code modulation.

Example 4 includes the apparatus of example 1, wherein the processor circuitry is to execute the instructions to transmit the concatenated output to a decoder of the imaging network circuitry.

Example 5 includes the apparatus of example 1, wherein in response to receiving an imaging task, the processor circuitry is to execute the instructions to selectively transmit the input image to an encoder of the imaging network circuitry.

Example 6 includes the apparatus of example 1, wherein the processor circuitry is to execute the instructions to perform a spatially separable depthwise convolution and a pointwise convolution.

Example 7 includes the apparatus of example 1, wherein the first output is an encoded feature map of at least 256 channels, and the second output is a less than 128 channel encoded feature map corresponding to an at least 1280×720 resolution input.

Example 8 includes a non-transitory computer readable medium comprising instructions, which, when executed, cause processor circuitry to at least transmit an input image to at least one of vision network circuitry and imaging network circuitry, generate, by the vision network circuitry, a first output based on a first feature map of the input image being generated by image scaling circuitry, generate, by the imaging network circuitry, a second output of the input image, upscale the first output, by bottleneck extender circuitry, to a resolution based on the second output, concatenate the first and second output to generate a concatenated output, apply a convolution operation to the concatenated output, and generate, by segmentation head circuitry, a pixel level segmentation class map from the concatenated output.

Example 9 includes the non-transitory computer readable medium of example 8, wherein the first feature map of the input image is a downscaled feature map describing features of the input image.

Example 10 includes the non-transitory computer readable medium of example 8, further including digital pulse-width modulation encoding circuitry to quantize the input image based on differential pulse code modulation.

Example 11 includes the non-transitory computer readable medium of example 8, wherein the instructions, when executed, cause the processor circuitry to transmit the concatenated output to a decoder of the imaging network circuitry.

Example 12 includes the non-transitory computer readable medium of example 8, wherein the instructions, when executed, cause the processor circuitry to selectively transmit the input image to an encoder of the imaging network circuitry.

Example 13 includes the non-transitory computer readable medium of example 8, wherein the instructions, when executed, cause the processor circuitry to perform a spatially separable depthwise convolution and a pointwise convolution.

Example 14 includes the non-transitory computer readable medium of example 8, wherein the first output is an encoded feature map of at least 256 channels, and the second output is a less than 128 channel encoded feature map corresponding to an at least 1280×720 resolution input.

Example 15 includes an apparatus comprising means for transmitting an input image to at least one of vision network circuitry and imaging network circuitry, means for generating, by the vision network circuitry, a first output based on a first feature map of the input image being generated by image scaling circuitry, means for generating, by the imaging network circuitry, a second output of the input image, means for upscaling the first output, by bottleneck extender circuitry, to a resolution based on the second output, means for concatenating the first and second output to generate a concatenated output, means for applying a convolution operation to the concatenated output, and means for generating, by segmentation head circuitry, a pixel level segmentation class map from the concatenated output.

Example 16 includes the apparatus of example 15, wherein the first feature map of the input image is a downscaled feature map describing features of the input image.

Example 17 includes the apparatus of example 15, further including means for quantizing the input image based on differential pulse code modulation.

Example 18 includes the apparatus of example 15, further including means for transmitting the concatenated output to a decoder of the imaging network circuitry.

Example 19 includes the apparatus of example 15, further including means for selectively transmitting the input image to an encoder of the imaging network circuitry.

Example 20 includes the apparatus of example 15, further including means for performing a spatially separable depthwise convolution and a pointwise convolution.

Example 21 includes the apparatus of example 15, wherein the first output is an encoded feature map of at least 256 channels, and the second output is a less than 128 channel encoded feature map corresponding to an at least 1280×720 resolution input.

Example 22 includes a method comprising transmitting, by executing an instruction with at least one processor, an input image to at least one of vision network circuitry and imaging network circuitry, generating, by the vision network circuitry, a first output based on a first feature map of the input image being generated by image scaling circuitry, generating, by the imaging network circuitry, a second output of the input image, upscaling, by bottleneck extender circuitry, the first output to a resolution based on the second output, concatenating, by executing an instruction with the at least one processor, the first and second output to generate a concatenated output, applying, by executing an instruction with the at least one processor, a convolution operation to the concatenated output, and generating, by segmentation head circuitry, a pixel level segmentation class map from the concatenated output.

Example 23 includes an apparatus to perform semantic image segmentation comprising mode selecting circuitry to transmit an input image to at least one of vision network circuitry and imaging network circuitry, the vision network circuitry to generate a first output based on a first feature map of the input image being generated by image scaling circuitry, the imaging network circuitry to generate a second output of the input image, bottleneck extender circuitry to upscale the first output to a resolution based on the second output, concatenate the first and second output to generate a concatenated output, and apply a convolution operation to the concatenated output, and segmentation head circuitry to generate a pixel level segmentation class map from the concatenated output.

Example 24 includes the apparatus of example 23, wherein the first feature map of the input image is a downscaled feature map describing features of the input image.

Example 25 includes the apparatus of example 23, further including digital pulse-width modulation encoding circuitry to quantize the input image based on differential pulse code modulation.

Example 26 includes the apparatus of example 23, wherein the bottleneck extender circuitry is to transmit the concatenated output to a decoder of the imaging network circuitry.

Example 27 includes the apparatus of example 23, wherein in response to receiving an imaging task, the mode selecting circuitry selectively transmits the input image to a decoder of the imaging network circuitry.

Example 28 includes the apparatus of example 23, wherein the bottleneck extender circuitry is to perform a spatially separable depthwise convolution and a pointwise convolution . the apparatus of example 23, wherein the first output is an encoded feature map of at least 256 channels, and the second output is a less than 128 channel encoded feature map corresponding to an at least 1280×720 resolution input. The following claims are hereby incorporated into this Detailed Description by this reference, with each claim standing on its own as a separate embodiment of the present disclosure.

Example 29 includes the method of example 22, wherein the first feature map of the input image is a downscaled feature map generated by trainable vision scaler circuitry.

Example 30 includes the method of example 22, further including quantizing the input image based on differential pulse code modulation.

Example 31 includes the method of example 22, further including transmitting the concatenated output to a decoder of the imaging network circuitry.

Example 32 includes the method of example 22, further including selectively transmitting the input image to an encoder of the imaging network circuitry.

Example 33 includes the method of example 22, further including performing a spatially separable depthwise convolution and a pointwise convolution.

Example 34 includes the method of example 22, wherein the first output is an encoded feature map of at least 256 channels, and the second output is a less than 128 channel encoded feature map corresponding to an at least 1280×720 resolution input.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent. The following claims are hereby incorporated into this Detailed Description by this reference, with each claim standing on its own as a separate embodiment of the present disclosure.

1. An apparatus comprising:
at least one memory;
instructions in the apparatus; and
processor circuitry to execute the instructions to:
transmit an input image to at least one of vision network circuitry and imaging network circuitry;
generate, by the vision network circuitry, a first output based on a first feature map of the input image being generated by image scaling circuitry;
generate, by the imaging network circuitry, a second output of the input image;
upscale the first output, by bottleneck extender circuitry, to a resolution based on the second output;
concatenate the first and second output to generate a concatenated output;
apply a convolution operation to the concatenated output; and
generate, by segmentation head circuitry, a pixel level segmentation class map from the concatenated output.

2. The apparatus of claim 1, wherein the first feature map of the input image is a downscaled feature map describing features of the input image.

3. The apparatus of claim 1, wherein the processor circuitry is to execute the instructions to quantize the input image based on differential pulse code modulation.

4. The apparatus of claim 1, wherein the processor circuitry is to execute the instructions to transmit the concatenated output to a decoder of the imaging network circuitry.

5. The apparatus of claim 1, wherein in response to receiving an imaging task, the processor circuitry is to execute the instructions to selectively transmit the input image to an encoder of the imaging network circuitry.

6. The apparatus of claim 1, wherein the processor circuitry is to execute the instructions to perform a spatially separable depthwise convolution and a pointwise convolution.

7. The apparatus of claim 1, wherein the first output is an encoded feature map of at least 256 channels, and the second output is a less than 128 channel encoded feature map corresponding to an at least 1280×720 resolution input.

8. A non-transitory computer readable medium comprising instructions, which, when executed, cause processor circuitry to at least:
transmit an input image to at least one of vision network circuitry and imaging network circuitry;
generate, by the vision network circuitry, a first output based on a first feature map of the input image being generated by image scaling circuitry;
generate, by the imaging network circuitry, a second output of the input image;
upscale the first output, by bottleneck extender circuitry, to a resolution based on the second output;
concatenate the first and second output to generate a concatenated output;
apply a convolution operation to the concatenated output; and
generate, by segmentation head circuitry, a pixel level segmentation class map from the concatenated output.

9. The non-transitory computer readable medium of claim 8, wherein the first feature map of the input image is a downscaled feature map describing features of the input image.

10. The non-transitory computer readable medium of claim 8, further including digital pulse-width modulation encoding circuitry to quantize the input image based on differential pulse code modulation.

11. The non-transitory computer readable medium of claim 8, wherein the instructions, when executed, cause the processor circuitry to transmit the concatenated output to a decoder of the imaging network circuitry.

12. The non-transitory computer readable medium of claim 8, wherein the instructions, when executed, cause the processor circuitry to selectively transmit the input image to an encoder of the imaging network circuitry.

13. The non-transitory computer readable medium of claim 8, wherein the instructions, when executed, cause the processor circuitry to perform a spatially separable depthwise convolution and a pointwise convolution.

14. The non-transitory computer readable medium of claim 8, wherein the first output is an encoded feature map of at least 256 channels, and the second output is a less than 128 channel encoded feature map corresponding to an at least 1280×720 resolution input.

15. An apparatus comprising:
means for transmitting an input image to at least one of vision network circuitry and imaging network circuitry;
means for generating, by the vision network circuitry, a first output based on a first feature map of the input image being generated by image scaling circuitry;
means for generating, by the imaging network circuitry, a second output of the input image;
means for upscaling the first output, by bottleneck extender circuitry, to a resolution based on the second output;
means for concatenating the first and second output to generate a concatenated output;
means for applying a convolution operation to the concatenated output; and
means for generating, by segmentation head circuitry, a pixel level segmentation class map from the concatenated output.

16. The apparatus of claim 15, wherein the first feature map of the input image is a downscaled feature map describing features of the input image.

17. The apparatus of claim 15, further including means for quantizing the input image based on differential pulse code modulation.

18. The apparatus of claim 15, further including means for transmitting the concatenated output to a decoder of the imaging network circuitry.

19. The apparatus of claim 15, further including means for selectively transmitting the input image to an encoder of the imaging network circuitry.

20. The apparatus of claim 15, further including means for performing a spatially separable depthwise convolution and a pointwise convolution.

21. The apparatus of claim 15, wherein the first output is an encoded feature map of at least 256 channels, and the second output is a less than 128 channel encoded feature map corresponding to an at least 1280×720 resolution input.

22. An apparatus to perform semantic image segmentation comprising:
mode selecting circuitry to transmit an input image to at least one of vision network circuitry and imaging network circuitry,
the vision network circuitry to generate a first output based on a first feature map of the input image being generated by image scaling circuitry,
the imaging network circuitry to generate a second output of the input image;
bottleneck extender circuitry to:
upscale the first output to a resolution based on the second output;
concatenate the first and second output to generate a concatenated output; and
apply a convolution operation to the concatenated output; and
segmentation head circuitry to generate a pixel level segmentation class map from the concatenated output.

23.-35. (canceled)
